(19) United States
(12) Patent Application Publication
(10) Pub. No.: US 2014/0132770 A1
(43) Pub. Date: May 15, 2014

(54) SIDE CAMERA SYSTEM FOR VEHICLE AND CONTROL METHOD THEREOF

(71) Applicant: KOREA ELECTRONICS TECHNOLOGY INSTITUTE, Seongnam-si (KR)

(72) Inventors: Sang Yub LEE, Yongin-si (KR); Sang Hyun PARK, Seongnam-si (KR); Hyo Sub CHOI, Jeollabuk-do (KR); Soo Young MIN, Suwon-si (KR)

(73) Assignee: KOREA ELECTRONICS TECHNOLOGY INSTITUTE, Seongnam-si (KR)

(21) Appl. No.: 14/080,200

(22) Filed: Nov. 14, 2013

(30) Foreign Application Priority Data
Nov. 14, 2012 (KR) 10-2012-0128789

(51) Int. Cl. H04N 7/18

(52) U.S. Cl. CPC H04N 7/18
USPC 348/148

(57) ABSTRACT

Provided herein is a vehicle side camera system and control method thereof. The vehicle side camera system according to the exemplary embodiment of the present disclosure controls the photographing direction and angle of a left/right side camera mounted on a left/right side mirror location of the vehicle based on driving information of the vehicle. Accordingly, it is possible to provide driver's convenience and safe driving, and especially, to remove dead zones occurring due to pillars when the driver makes a turn.

### CROSS-REFERENCE TO RELATED APPLICATIONS

This application claims the benefit of priority under 35 U.S.C. §119(a) of Korean Patent Application No. 10-2012-0128789, filed on Nov. 14, 2012, in the Korean Intellectual Property Office, the entire disclosure of which is incorporated herein by reference for all purposes.

### BACKGROUND

1. Field

The following description relates to a vehicle, and more particularly, to an intelligent vehicle configured to use a camera to provide useful information to a driver.

2. Description of Related Art

FIG. 1 is a photograph of a vehicle side mirror to which a subsidiary mirror has been added. As illustrated in FIG. 1, in order to supplement a short-distance view, an additional prosthesis should be added to the side mirror. However, it is not only inconvenient to install the prosthesis, but the prosthesis would affect the aesthetic appearance of the vehicle.

Furthermore, a vehicle pillar is an element that interferes with the driver's view, making it difficult for the driver to see an approaching object. FIG. 2 is a view illustrating dead zones that may occur due to vehicle pillars.

Of among the dead zones occurred due to the vehicle pillars, the dead zone that occurs in the front direction is the zone of the location of an object approaching the vehicle when the vehicle makes a turn in a curved road.

### SUMMARY

The present invention was devised to resolve the aforementioned problems, and the purpose of the present invention is to provide a vehicle side camera system configured to control a side camera mounted on a side mirror location of a vehicle according to driving of the vehicle.

In one general aspect, there is provided a vehicle side camera system comprising: a left side camera mounted on a location of a left mirror of a vehicle; a left side camera driver configured to drive the left side camera, to adjust a photographing direction and photographing angle of the left side camera; a right side camera mounted on a location of a right mirror of the vehicle; a right side camera driver configured to drive the right side camera, to adjust a photographing direction and photographing angle of the right side camera; and a controller configured to control the left side camera driver and right side camera driver, based on driving information of the vehicle.

In addition, the controller may control a driving operation of the left side camera driver and right side camera driver so that the left side camera photographs a front direction and the right side camera photographs a rear direction, when the vehicle makes a left turn, and control a driving operation of the left side camera driver and right camera driver so that the right side camera photographs a front direction and the left side camera photographs a rear direction, when the vehicle makes a right turn.

Furthermore, the controller may control a driving operation of the left side camera driver and right side camera driver so that both the left side camera and right side camera photograph a rear direction, when the vehicle goes straight or makes a reverse.

In addition, the left side camera and right side camera may photograph selectively using a wide viewing angle lens and narrow viewing angle lens.

In addition, the left side camera and right side camera may photograph a thermal image or infrared image.

Furthermore, vehicle side camera system may further comprise a left display located in a left pillar of the vehicle, and display a left image photographed by the left side camera; and a right display located in a right pillar of the vehicle, and display a right image photographed by the right side camera.

Furthermore, the controller may notify a warning device when there is an object approaching the vehicle in the left image photographed by the left side camera or the right image photographed by the right side camera.

In one general aspect, there is provided a vehicle side camera control method comprising: obtaining driving information of the vehicle; adjusting a photographing direction and photographing angle of a left side camera mounted on a left side minor location of the vehicle based on driving information of the vehicle; and adjusting a photographing direction and photographing angle of a right side camera mounted on a right side minor location of the vehicle based on driving information of the vehicle.

As explained above, according to an exemplary embodiment of the present disclosure, it is possible to operate a side camera mounted on a side mirror location of a vehicle while controlling the side camera according to a driving of the vehicle, providing driver's convenience and safe driving. Especially, it is possible to remove dead zones occurring due to pillars during a turn driving.

In addition, according to an exemplary embodiment of the present disclosure, it is possible to sense a moving route and proximate dead zone of a long distance and short distance object using dual lens (wide viewing angle lens, narrow viewing angle lens), thereby becoming capable of warning the driver about an approaching object.

Not only that, using a narrow view angle lens, it is possible to make a warning and safety action so as to avoid any accident from occurring with another vehicle that moves pass the door when a driver and passenger opens the door.

### BRIEF DESCRIPTION OF THE DRAWINGS

FIG. 1 is a photograph of a vehicle side mirror to which a subsidiary minor has been added;

FIG. 2 is a view showing dead zones that may occur due to vehicle pillars;

FIG. 3 is a view illustrating an exterior of a vehicle to which a side camera has been applied according to an exemplary embodiment of the present disclosure;

FIG. 4 is a view illustrating a photograph image taken by a wide viewing angle lens and a photograph image taken by a narrow viewing angle lens;

FIG. 5 is a view illustrating a side camera driving method,

FIGS. 6 and 7 are views provided to explain a side camera gazing direction during a left turn;

FIG. 8 is a view provided to explain a side camera gazing direction during a right turn;

FIG. 9 is a view illustrating an image photographed by a side camera during a right turn displayed on a display;

FIG. 10 is an internal block diagram of a vehicle side camera system according to an exemplary embodiment of the present disclosure; and

FIG. 11 is a view provided to explain a process for controlling driving of a side camera by a vehicle side camera system illustrated in FIG. 10.

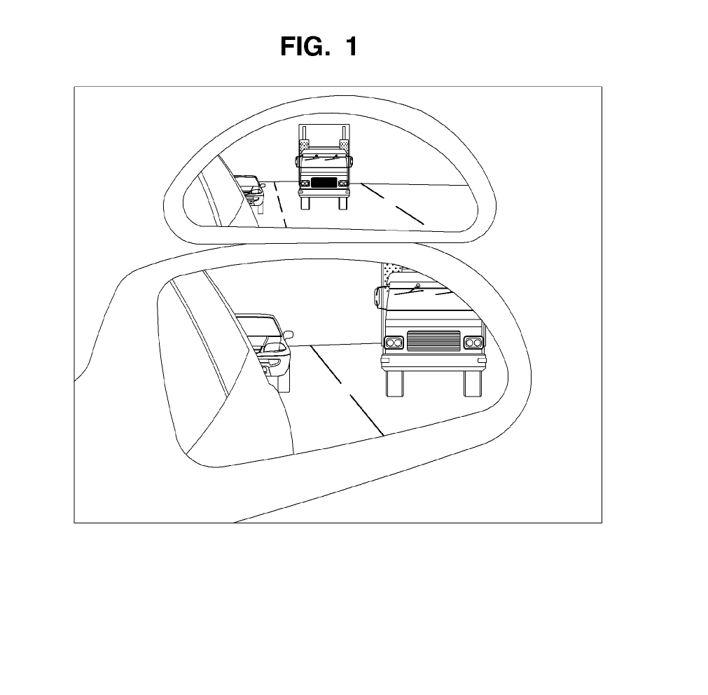

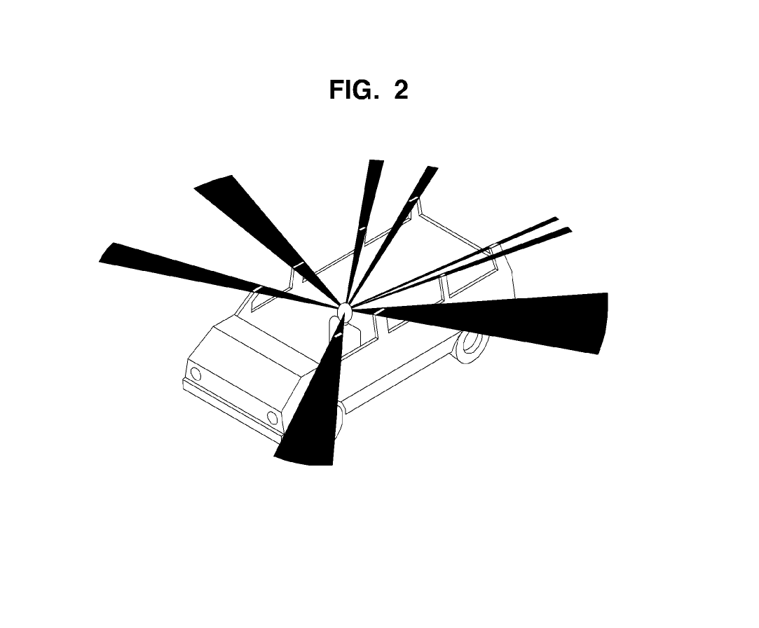

Throughout the drawings and the detailed description, unless otherwise described, the same drawing reference numerals will be understood to refer to the same elements, features, and structures. The relative size and depiction of these elements may be exaggerated for clarity, illustrating, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses and/or methods described herein will be suggested to those of ordinary skill in the art. Also, descriptions of well-known functions and constructions may be omitted for increased clarity and conciseness.

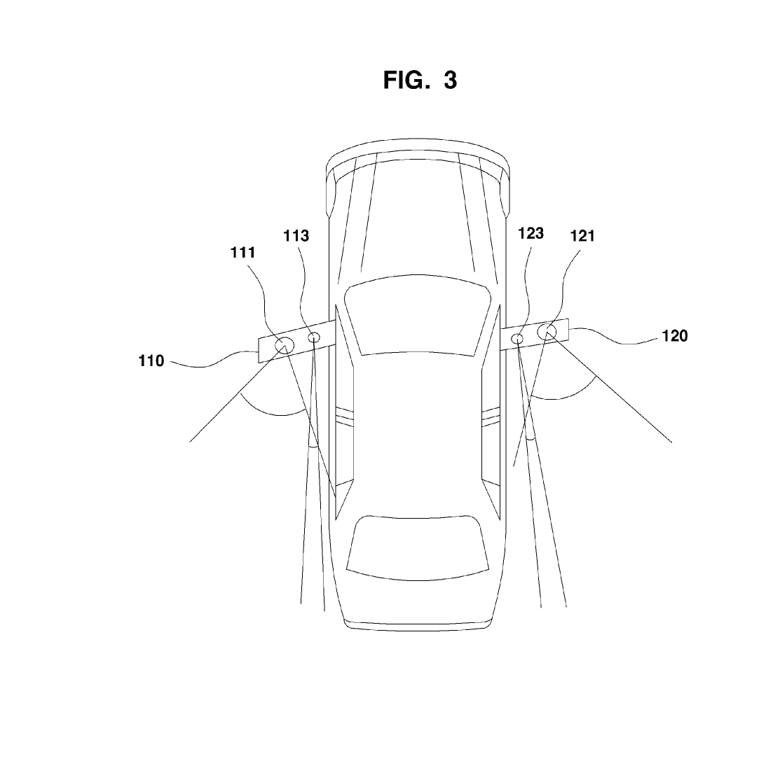

FIG. 3 is a view illustrating an exterior of a vehicle to which a side camera has been applied according to an exemplary embodiment of the present disclosure. As illustrated in FIG. 3, on a vehicle according to the present exemplary embodiment, a side camera 110, 120 is mounted instead of a side mirror.

The side camera 110, 120 is provided with a wide viewing angle lens 111, 121 and a narrow viewing angle lens 113, 123. As illustrated in FIG. 3, the reason why the narrow viewing angle lens 113, 123 is placed in the inside is because the narrow viewing angle lens 113, 123 is suitable to sense a long distance object. If the narrow viewing angle lens 113, 123 is placed in the outside, in a vehicle having a long body such as a bus or commercial car and not a passenger car, it is difficult to gaze a long distance object in the rear direction.

The side camera 110, 120 selects and photographs one of the wide viewing angle lens 111, 121 and narrow viewing angle lens 113, 123. The lens to be used in the photographing may be selected by the driver, or may be selected automatically, or may be selected by the driver and also selected automatically as well. However, in this case, there must be two image sensors in each side camera 110, 120.

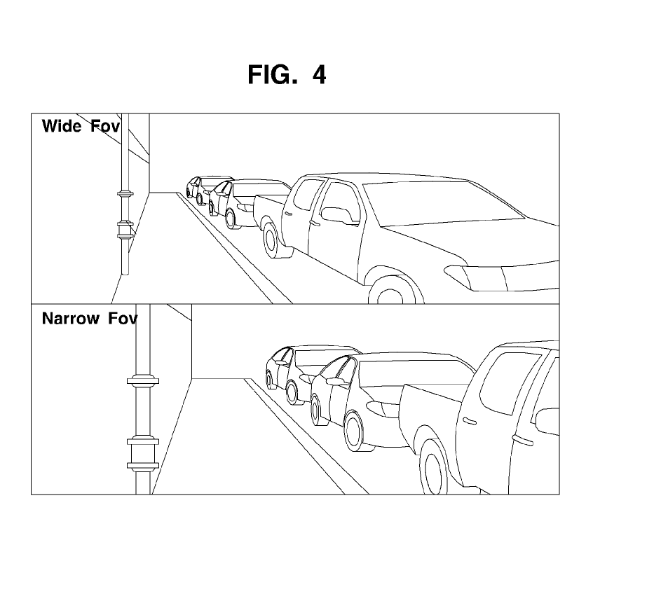

FIG. 4 illustrates an example of an image photographed by a wide viewing angle lens 111, 121 and an image photographed by a narrow viewing angle lens 113, 123.

Not only is it possible to analyze the image photographed by a side camera 110, 120 and sense an object approaching to the vehicle, it is also possible to presume moving information of the object and provide the presumed information. Herein, the moving information of the object may be represented by an arrow on the image. A moving direction may be represented by the direction of the arrow, while a moving velocity may be indirectly represented by the length of the arrow.

Especially, when an object approaches a side of the vehicle, it is possible to make the door of the vehicle to be forcibly locked and seek safety.

Meanwhile, the side camera 110, 120 may be further provided with a lens for thermal image/infrared photographing. This is very effective when used during night driving or for identifying obstacles.

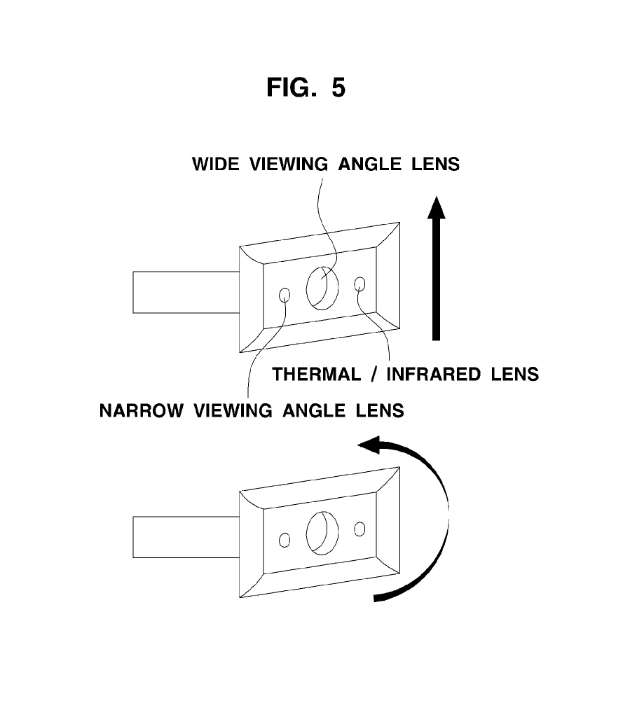

In addition, the side camera 110, 120 may be driven by driving means(not illustrated) to photograph not only the rear direction but also the front direction. Furthermore, the photographing angle may be adjusted. FIG. 5 illustrates a driving method of the side camera 110, 120.

The side camera 110, 120 may be driven automatically according to the state of driving of the vehicle, which is for the convenience and safe driving of the driver. Hereinbelow is detailed explanation on how the side camera 110, 120 is driven.

When the vehicle is moving forward or reversing, as illustrated in FIG. 3, the side camera 110, 120 photographs while gazing in the rear direction. Herein, the wide viewing angle lens 111, 121 of the side camera 110, 120 is used to gaze/photograph a rear dead zone.

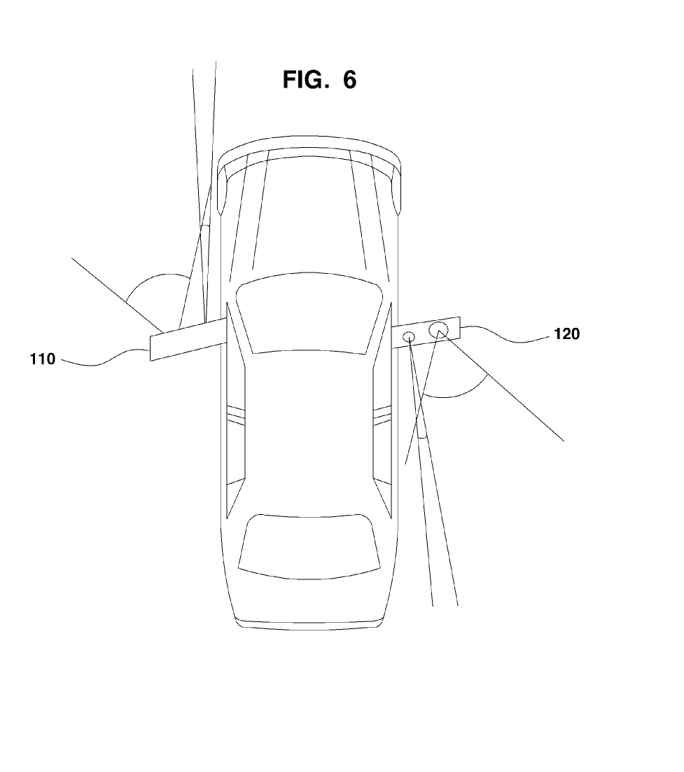

Meanwhile, when a handle of the vehicle is turned counterclockwise by or more than a certain angle to make a left turn, as illustrated in FIG. 6, the left side camera 110 is driven to gaze in the front direction. On the other hand, the right side camera 120 keeps gazing in the rear direction.

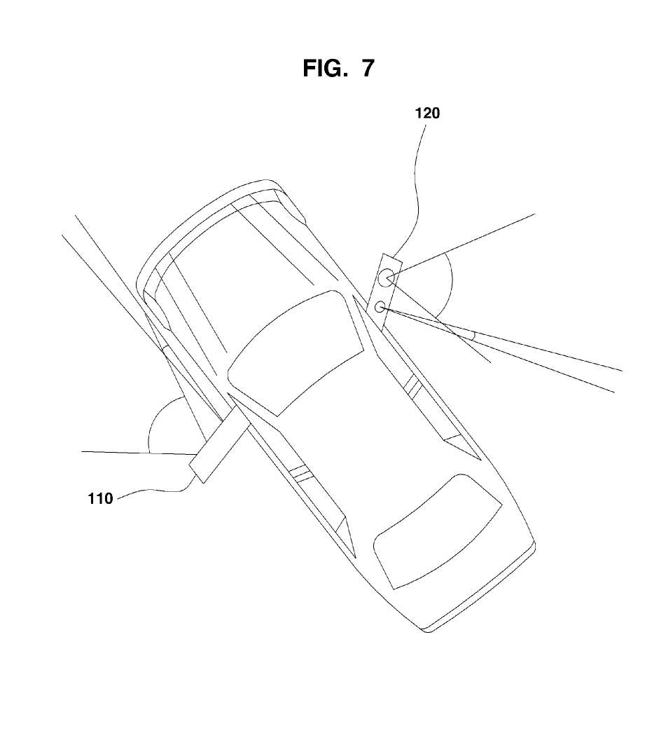

The gazing angle of the right side camera 120 changes adaptably according to the left turn angle. The greater the left turn angle (that is, a steep left turn), as illustrated in FIG. 7, the right side camera 120 gazes the right or the right front direction.

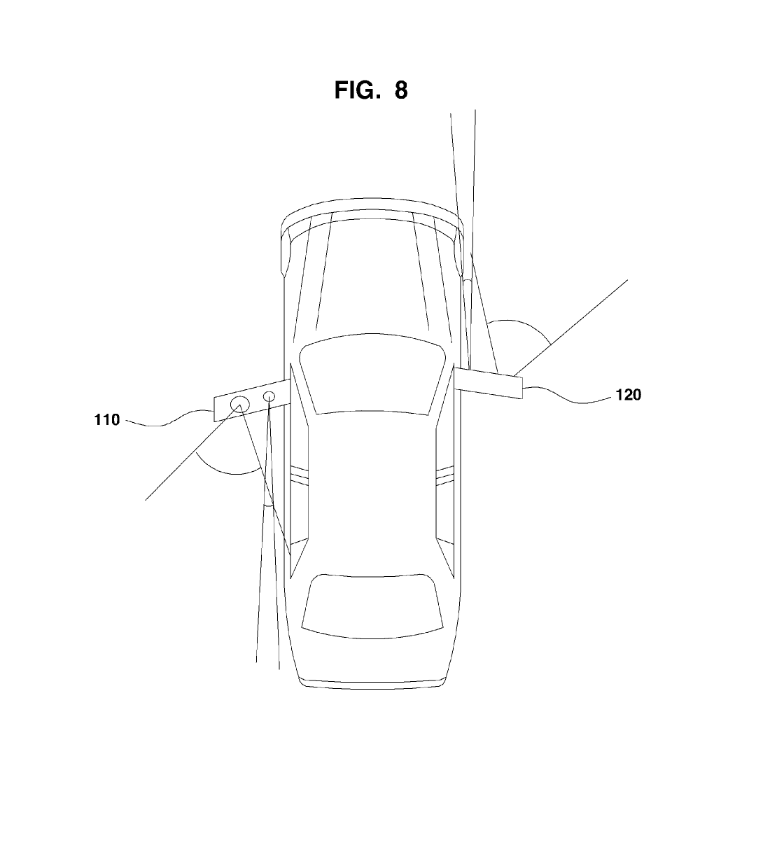

On the other hand, when the handle of the vehicle is turned clockwise by or more than a certain angle, as illustrated in FIG. 8, the right side camera 120 is driven to gaze in the front direction. Meanwhile, the left side camera 110 is driven to gaze in the rear direction.

The gazing angle of the left side camera 110 changes adaptably according to the right turn angle. The greater the right turn angle (that is, a steep right turn), the right side camera 120 gazes the right front direction rather than the right rear direction.

Meanwhile, an image photographed by the left side camera 110 is displayed on a left display installed on a left front pillar, and an image photographed by a right side camera 120 is displayed on a right display installed on a right front pillar.

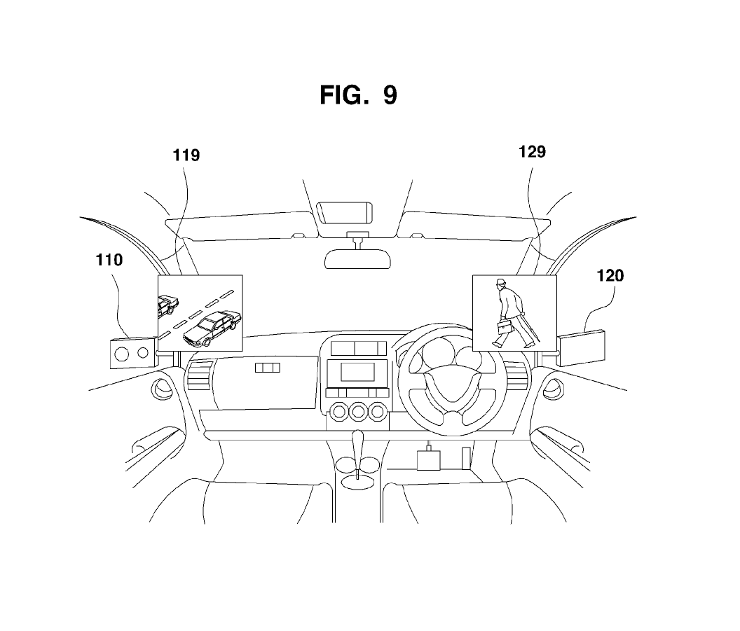

FIG. 9 illustrates a result of an image photographed by the side camera 110, 120 and then displayed on the display 119, 129 during a right turn. As illustrated in FIG. 9, an image photographed by the left side camera 110 is displayed on a left display 119 while an image photographed by a right side camera 120 is displayed on a right display 129.

Meanwhile, during a right turn, the left side camera 110 gazes/photographs in the rear direction, while the right side camera 120 gazes/photographs in the front direction. Therefore, in FIG. 9, an image of a left rear direction is shown on the left display 119, while an image of a right front direction is shown on the right display 129.

The image of the right front direction displayed on the right display 129 is the portion hidden by the right pillar which would have been a dead zone to the driver if it were not provided.

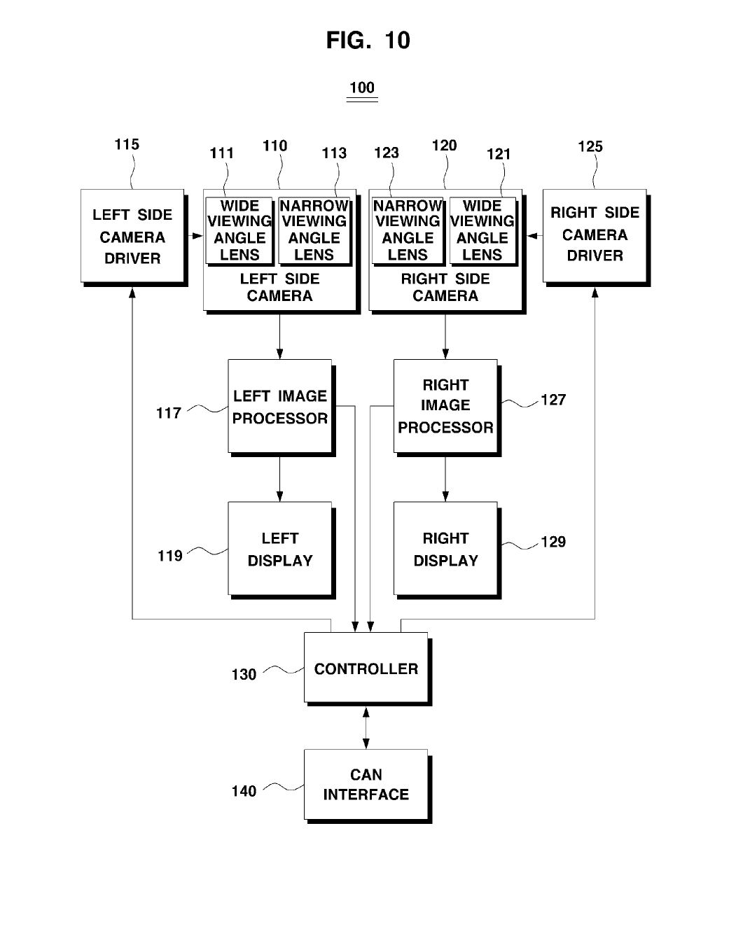

Hereinbelow is detailed explanation on the configuration of the inside of a vehicle side camera according to the present exemplary embodiment, with reference to FIG. 10. FIG. 10 is an internal block diagram of a vehicle side camera system according to the present exemplary embodiment.

As illustrated in FIG. 10, a vehicle side camera system 100 according to the present exemplary embodiment includes a left side camera 110, left side camera driver 115, left image processor 117 and left display 119, right side camera 120, right side camera driver 125, right image processor 127 and right display 129, and controller 130 and CAN (Controller Area Network) interface 140.

The left side camera 110 selectively uses the wide viewing angle lens 111 and narrow viewing angle lens 113 to photograph a front direction or rear direction of the left side of the vehicle to generate an image. The left side camera driver 115 adjusts the gazing direction (front direction/rear direction) of the camera 110.

The left image processor 117 performs image processing on the left image of the vehicle photographed by the left side camera 110. An image processing performed in the left image processor 117 may be a general image processing or an image recognition. An image recognition may include sensing an object approaching the vehicle but may also include calculating moving information (moving direction and moving velocity).

On the left display 119, a left image processed in the left image processor 117 is displayed, wherein an image recognition result may be displayed together.

The right side camera 120, right side camera driver 125, right image processor 127, and right side display 129 photographs/processes/displays the right and not the left of the vehicle. Detailed explanation could be presumed from the detailed explanation on the left side camera 110, left side camera driver 115, left image processor 117, and left display 119, and thus detailed explanation thereof is omitted.

The controller 130 obtains steering angle information of the vehicle from a steering angle sensor through a CAN interface 140. In addition, the controller 130 controls the left/right side camera drivers 115, 125 according to the obtained steering angle information, and controls the photographing direction and angle of the left/right side cameras 110, 120.

In addition, the controller 130 transmits the result of an image recognition performed by the left/right image processor 117, 127 to a warning device or safety device connected to the CAN interface 140, so that a warning/alarm action by a warning device and a safety action such as brake etc. by a safety device may be performed.

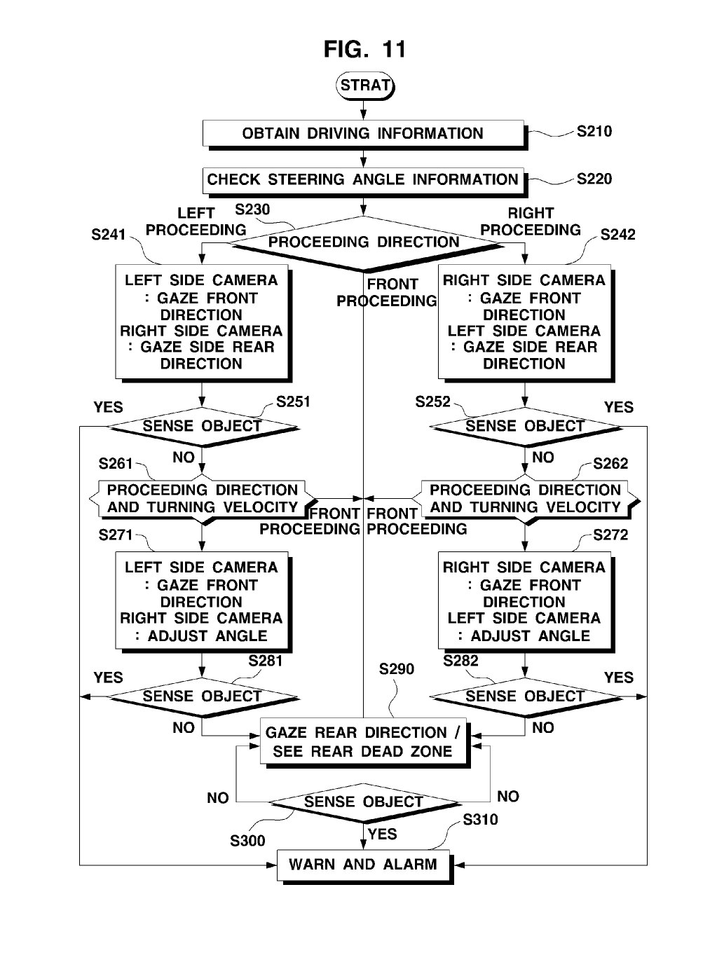

Hereinbelow is detailed explanation on a process of controlling driving of a camera by a vehicle side camera system 110 illustrated in FIG. 10, with reference to FIG. 11.

As illustrated in FIG. 11, the controller 130 obtains driving information through the CAN interface 140 (S210), and checks steering angle information of the vehicle from the obtained driving information.

When the proceeding direction of the vehicle is the front direction (that is, moving forward or reversing) (S230-front proceeding) as a result of checking the steering angle information at S220, the controller 130 controls the left/right side camera driver 115, 125 so that the left/right side cameras 110, 120 all gaze in the rear direction (S290).

Herein, when an approaching object is sensed in a left/right image photographed by the left/right side camera 110, 120 (S300-Yes), the controller 130 notifies the warning device through the CAN interface, so that a warning/alarm action can be made (S310).

Meanwhile, when the proceeding direction of the vehicle is the left direction(that is, left turn) (S220-left proceeding) as a result of checking the steering angle information at S220, the controller 130 controls the left/right side camera driver 115, 125 so that the left side camera 110 gazes in the front direction and the right side camera 120 gazes in the rear direction (S241).

Next, when an approaching object is sensed in a left/right image photographed by the left/right side camera 110, 120 (S251-Yes), the controller 130 notifies this to the warning device through the CAN interface 140, so that a warning/alarm action can be made (S310).

When a left turn is continued (S261-left proceeding continued), the controller 130 controls the right side camera driver 125 so that the photographing angle of the right side camera 120 changes adaptably according to the left turn angle (S271).

In this process, when an approaching object is sensed in a left/right image photographed by the left/right side camera 110, 120 (S281-Yes), the controller 130 notifies this to the warning device through the CAN interface 140, so that a warning/alarm action can be made (S310).

Meanwhile, when the proceeding direction of the vehicle is the right side(that is, right turn) (S230-right proceeding) as a result of checking the steering angle information at S220, steps S242 to S282 are performed. Detailed explanation on steps S242 to S282 may be presumed from the detailed explanation on steps S241 to S281, and thus is omitted.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A vehicle side camera system comprising:
a left side camera mounted on a location of a left mirror of a vehicle;
a left side camera driver configured to drive the left side camera, to adjust a photographing direction and photographing angle of the left side camera;
a right side camera mounted on a location of a right mirror of the vehicle;
a right side camera driver configured to drive the right side camera, to adjust a photographing direction and photographing angle of the right side camera; and
a controller configured to control the left side camera driver and right side camera driver, based on driving information of the vehicle.

2. The vehicle side camera system according to claim 1,
wherein the controller controls a driving operation of the left side camera driver and right side camera driver so that the left side camera photographs a front direction and the right side camera photographs a rear direction, when the vehicle makes a left turn, and
controls a driving operation of the left side camera driver and right camera driver so that the right side camera photographs a front direction and the left side camera photographs a rear direction, when the vehicle makes a right turn

3. The vehicle side camera system according to claim 2,
wherein the controller controls a driving operation of the left side camera driver and right side camera driver so that both the left side camera and right side camera photograph a rear direction, when the vehicle goes straight or makes a reverse

4. The vehicle side camera system according to claim 1,
wherein the left side camera and right side camera photographs selectively using a wide viewing angle lens and narrow viewing angle lens

5. The vehicle side camera system according to claim 4,
wherein the left side camera and right side camera may photograph a thermal image or infrared image

6. The vehicle side camera system according to claim 1,
further comprising a left display located in a left pillar of the vehicle, and displays a left image photographed by the left side camera; and
a right display located in a right pillar of the vehicle, and displays a right image photographed by the right side camera

7. The vehicle side camera system according to claim 1,
wherein the controller notifies a warning device when there is an object approaching the vehicle in the left image photographed by the left side camera or the right image photographed by the right side camera

8. A vehicle side camera control method comprising:
obtaining driving information of the vehicle;
adjusting a photographing direction and photographing angle of a left side camera mounted on a left side minor location of the vehicle based on driving information of the vehicle; and
adjusting a photographing direction and photographing angle of a right side camera mounted on a right side minor location of the vehicle based on driving information of the vehicle
